(19) United States
(12) Patent Application Publication
(10) Pub. No.: US 2009/0107416 A1
(43) Pub. Date: Apr. 30, 2009

(54) Bird Scooter Amusement Device

(76) Inventor: Patricia M. Handal, South Lake Tahoe, CA (US)

Correspondence Address: BERENATO, WHITE & STAVISH, LLC, 6550 ROCK SPRING DRIVE, SUITE 240, BETHESDA, MD, 20817, US

(21) Appl. No.: 12/258,442

(22) Filed: Oct. 26, 2008

Related U.S. Application Data
(60) Provisional application No. 60/983,116, filed on Oct. 26, 2007.

(51) Int. Cl. A01K 29/00

(52) U.S. Cl. 119/707

(57) ABSTRACT

The invention is a low center of gravity animal toy. The toy is a scooter type device that includes a cross bar mounted on a pedestal. The cross bar is knurled for extra grip and enables an animal, usually a large bird, to grip the cross bar with their beak and scooter over a surface. Safe and fun interactive and solo play for parrots or other animals is provided.

This application claims the benefit of Provisional Application No. 60/983,116, filed Oct. 26, 2007.

### BACKGROUND OF THE INVENTION

1. Field of the Invention

The present invention relates to a colorful rolling toy for use in training and amusing animals; primarily large birds. Specifically, the invention is a colorful anodized aluminum rolling toy with a yoke mounted cross bar mounted on top of a pedestal and wheels at each end to enable the toy to roll smoothly over a surface.

2. Description of the Prior Art

Pet owners enjoy interactive contact with their pets. Owners talk to their pets, play with them, exercise together, and generally pal around for companionship purposes. Items like training devices and toys that promote safe owner/pet interaction have long been popular. Stepping into a pet store, a pet owning person is confronted with an almost endless array of toys ranging from sticks (literally) to computerized devices with web cameras, joy stick remote control, etc.

A primary concern of any pet owner is the safety and durability of the toy as well as general suitability of the toy for the pet. Not all toys suit all pets.

Small pets can make great use of some items made of plastic, wood, rubber, whereas larger pets might claw, chew, and swallow the same toy in the blink of an eye. In addition, pets and owners both become bored with repetitive toy interaction over time. A preferred toy is one that creates unique interaction for the pet/owner and occasional onlooker who can likewise be entertained in the same way as is the pet and owner.

Hence, a useful toy for animals that can resist destruction from casual use by the animal and owner, and at the same time create unique interaction between the owner and pet with almost every use, would be desirable.

### SUMMARY OF THE INVENTION

The present invention relates to a colorful anodized aluminum rolling toy with a yolk mounted beak grip bar on top and 2 wheels. The invention is preferably comprised of 6061-TS grade aluminum, although other sturdy chew resistant materials can be used. When made of aluminum, a soft anodizing process is used to provide color and a smooth non-toxic surface finish to the final product. There are 2 colors used for each scooter. The body of the scooter is a flat rectangular platform. Side rails are screwed to the body using grade 5 fasteners which capture the axle and wheel assemblies. An additional piece is a pedestal that is drilled and tapped. A hole is drilled through from the bottom to the top of the platform for a grade 5 fastener to be inserted through and screwed into the bottom end of the pedestal to hold it in place. The top end of the pedestal is also drilled and tapped for a “U” shaped yoke to attach again using a grade 5 fastener. The yoke has a knurled cross bar or beak grip for the bird's beak to grasp which is also fastened using 2 grade 5 fasteners. The upright tubular rod pedestal has a slight backwards angle for esthetics and to enhance usability: Small=8°+/−1-2°, Medium=13°+/−1-2°, Large=17°+/−1-2°.

Modifications in styling or materials can provide an end product with the same or similar functionality. For example, the cross bar beak grip could be wider or higher. The wheels could be attached differently (i.e., screwed on) or attached as individual wheels at the respective corners of the body platform (i.e., skateboard style). The platform could be somewhat thinner/longer. Instead of aluminum, as already mentioned, wood or plastic could be used. Caution should be used, however, inasmuch as if a non-metal device is used with larger parrots, such a toy would likely be destroyed rapidly, and the chewed off parts could be ingested which could prove fatal.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a top and left side perspective view of the bird scooter according to the present invention.

FIG. 2 is a left side view of the bird scooter of FIG. 1.

FIG. 3 is a right side view of the bird scooter of FIG. 1.

FIG. 4 is a front view of the bird scooter of FIG. 1.

FIG. 5 is a rear view of the bird scooter of FIG. 1.

FIG. 6 is a top plan view of the bird scooter of FIG. 1

FIG. 7 is a bottom plan view of the bird scooter of FIG. 1.

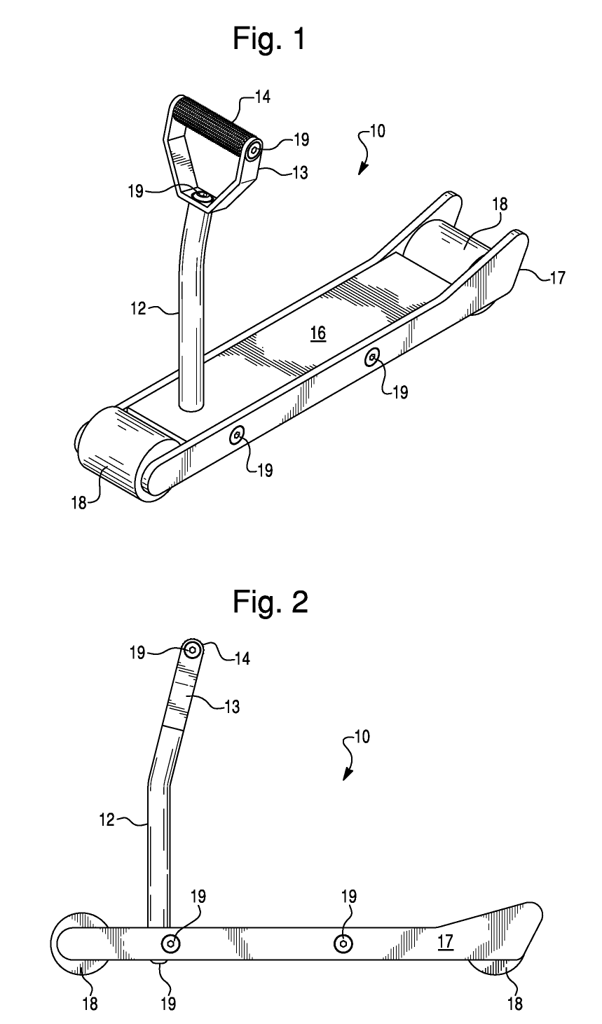

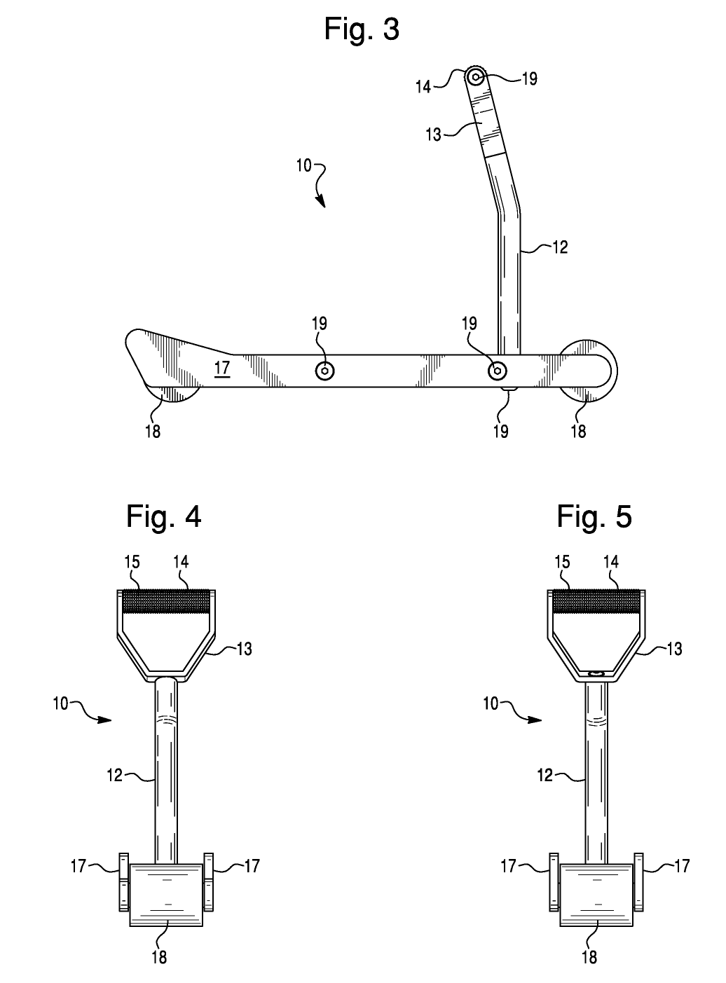

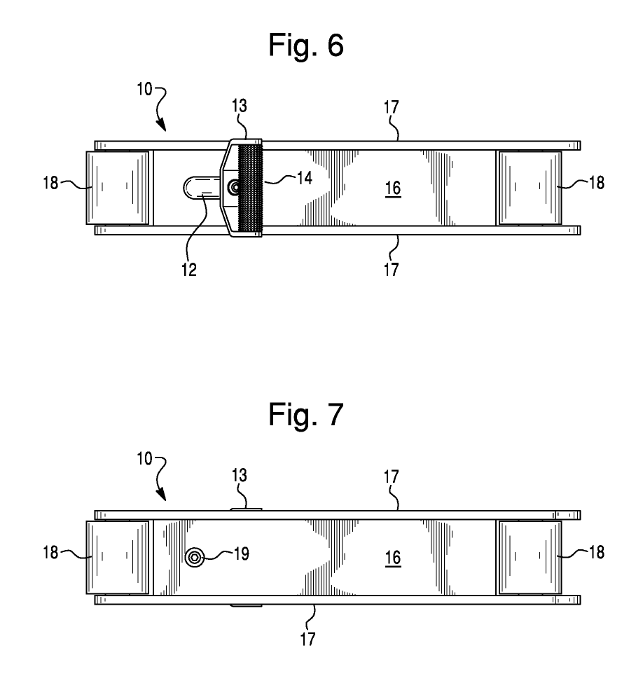

### DETAILED DESCRIPTION

With reference to the drawing figures: The scooter 10 includes a platform body element 16 that is longitudinally oriented. The body 16 includes axles attached or captured between, preferably, at respective ends thereof, separate side rails 17 mounted alongside the body 16 and attached through fasteners 19 thereto. Wheels 18 are respectively fastened to the axles by either pressing (friction interference fit) or through separate fasteners that allow for smooth rotation. The objective is to create a relatively stable low-slung, low center of gravity, easily rollable platform for the balance of the scooter 10 elements.

The scooter body 16 has an upright pedestal 12 attached thereto. This pedestal element 12 can likewise be interference press fit into a drilled hole in the scooter body 16 or can be attached with a fastener 19 attached through a hole drilled entirely through the scooter body 16 (as shown). A preferred form of the pedestal is a bent tubular bar. A yolk 13 includes a mounted cross bar beak grip 14 with a knurled finish 15. The yolk 13 is attached on to upper end of the pedestal 12. The yolk 13 can be press fit onto the end of the pedestal 12 or can be fastener equipped, i.e., a threaded dowel or fastener 19 (as shown), so as to firmly associate the pedestal and yolk. The knurling or texturing 15 is useful in providing a relatively high grip surface for the animal (i.e., large bird) to manipulate the scooter during use.

The final product is a rolling platform with a knurled beak grip to prevent slippage on the upright yoke. The bird will place one foot on the rectangular platform and grasp the knurled cross bar beak grip on the yoke with their beak. This allows for balancing on the unit in an upright position. With the free leg, the bird will place their foot on the ground and use it in a forward to backwards sweeping motion to propel the unit in a forward direction. Many birds will also use the knurled surface of the knurled cross bar on the yoke to chew on and rub their beak. This helps to clean the beak and keep the shape and prevent overgrowth.

The preferred material for constructing the scooter is aluminum, but other materials can be used. The requirements are that the material chosen be sufficiently resistant to destructive engagement with the animal using the scooter. Metal or aluminum is preferred because of its durability in this use with large birds. Another feature of the relative proportions of the scooter as shown, length of the body, width of the end mounted wheel, etc. and the metal selected results in ⅔ to ¾ of the weight of the scooter being in the body/wheel and body/wheel/side rail elements of the scooter. This creates a center of gravity that is low in the device, relatively near the surface being rolled upon, and provides a sense of stability and security to the bird and owner/trainer. The low center of gravity and relative heft provide stability and resistance to tipping thereby enabling secure scooting.

The scooter can be decorated (with a non-toxic variety of decals, paints, etc.) and can be used for other species of animals besides birds such as rats, hamsters, gerbils, guinea pigs, squirrels, or other pocket pets. Also, some non-psittacine birds such as raptors, hawks, eagles, owls, falcons) may utilize the toys in a show setting such as at a zoo or wildlife park. The device is available in at least 3 sizes for parrots and other types of birds and small animals of most sizes and weights.

The scooter body element 16 can range in size, for example, from about 2.5-8.5 inches in length, with a cross section of about ⅜ inch×¾ inch in the shorter length scooter bodies, to a thicker heavier ¾ inch×1¾ inch section in the longer length scooter bodies. Likewise wheels 18 can range in size from about ¾ inch diameter with a ¾ inch width in the smaller scooter, to about a 1½ inch diameter with a 1⅝ inch width for the larger scooter. The side rails 17, shaped to complement the adjacent body element, can vary in thickness from about ⅛ inch to 3/16 inch so as to be sufficiently stiff to capture the wheel axles and support the rolling of the scooter over surfaces. The gap between the respective wheels and body element edge(s) should be maintained small enough to prevent insertion and trapping of a larger bird claw in the large scooters, and be maintained large enough in the small scooters to conversely prevent capture of an inserted smaller bird claw. In the medium and larger scooter this gap should be about ⅛ inch or less. In the smaller scooter the gap should be about ¼ inch and larger.

The pedestal and beak grip are preferably made from a hollow tube ranging in diameter from about ¼ inch to ½ inch with the pedestal having a rearward bend as noted above. The overall height of the mounted and assembled beak grip above a surface would be in the range of about 3-8 inches. Scooter weights with the above construction will be in the 4-5 oz. range for smaller scooters to slightly over 2 lbs for the largest. In each case, the center of gravity is quite low owing to the weight being concentrated in the wheels/body/side rails. In addition, the length to width ratio of about 6 to 1 or less ensures adequate stability. This ratio can be modified somewhat, but a preferred ratio is about 5 to 1.

Other configurations of the body element and wheels can be used, i.e., a skate board style (as noted above) separately wheeled axle assembly with the wheels at or near the corners of the body element for stability. Likewise the pedestal may be curved as opposed to bent, etc.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. Specifically, various materials and sizes are provided, such as for example the size of various pieces/selection of materials/types of fasteners. These are intended to be illustrative and to convey the preferences of the inventor, and are not intended to be limiting or suggest that the use of components of different sizes and shapes are outside the scope of the present invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. An animal toy, comprising:
a longitudinal body element having an upper side and a lower side;
wheels attached to said body element at respective ends thereof for enabling said body element to roll smoothly over a surface, said wheel attached so as to prevent tipping of said toy side to side and maintain said toy in an upright position while at rest;
a pedestal mounted on said upper surface and a cross bar mounted to said pedestal to enable an animal to grip said cross bar and thusly move said toy under the control of said animal;
whereby
said animal may stand upon said body element with one leg and, simultaneously gripping said cross bar, with a sweeping motion of another leg, propel said toy over a surface.

2. An animal toy as in claim 1, wherein:
said cross bar is knurled so as to enhance grip between an animal extremity and said cross bar.

3. An animal toy as in claim 2, wherein:
the number of wheels is at least two wheels that are each rotatably mounted at respective ends of said body and are captured for rotation between side rails that are attached to respective sides of said body element.

4. An animal toy as in claim 1, wherein:
each of said body element, pedestal cross bar, and wheels are made from metal.

5. An animal toy as in claim 4, wherein:
said metal is aluminum.

6. An animal toy as in claim 1, wherein:
a ratio of an overall length of said toy to its width is less than about 6 to 1.

7. An animal toy as in claim 1, wherein:
said body element and wheels comprise at least ⅔ of the weight of the toy.
